(19) United States
(12) Patent Application Publication
(10) Pub. No.: US 2008/0276538 A1
(43) Pub. Date: Nov. 13, 2008

(54) Glass Channel for Integrated Channel/Regulator in Vehicle Door

(75) Inventor: Terrence P. Costigan, Fenton, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/746,079

(22) Filed: May 9, 2007

(51) Int. Cl. B60J 10/02; B60J 1/17

(52) U.S. Cl. 49/375; 296/146.2

(57) ABSTRACT

A rear integrated channel/regulator for use below a beltline in a vehicle door is disclosed. The channel/regulator may be part of a latch/window regulator module and may comprise a window regulator guide rail and a below belt glass run channel fixed to the guide rail. The glass run channel may have an upper channel portion extending downward from a top end, a lower channel portion extending upward from a bottom end, and an intermediate channel portion extending between the upper channel portion and the lower channel portion, with the upper channel portion having a first constant width, the lower channel portion having a second constant width that is smaller than the first constant width and the intermediate channel portion tapering from the first constant width to the second constant width.

### BACKGROUND OF THE INVENTION

The present application relates generally to a vehicle door, and more particularly to vehicle doors having integrated channel/regulators.

For typical vehicle doors with a movable window glass, glass run channel assemblies are separate from window regulator guide rails. The guide rails, along with the rest of the window regulator assembly, are typically located between and spaced from the glass run channels. Thus, the different assemblies can be installed and aligned separately. More recently, some have proposed combining the glass run channels and the window regulator assemblies into one subassembly. However, this can make alignment of components during assembly more difficult. The misalignment of certain components can have undesirable consequences.

For example, it is important for conventional vehicle side door glass guidance systems with below belt glass run channels to assure proper alignment of the below belt glass run channel with an above belt seal (that extends along the window frame of the door). Proper alignment helps assure that the window glass will move up and down in the run channels and seals with minimal effort. Any inboard/outboard misalignment of the above belt to below belt sections, on the other hand, can cause undesirable effects on window movement effort. With the conventional glass run channels separate from the window regulator assembly, the ability to assure proper alignment is relatively easy. However, with a combined glass run channel and window regulator assembly, the ability to align the rear below belt glass run channel with an above belt seal becomes much more difficult.

One possible solution, making the above belt and below belt channels one piece, eliminates the misalignment concern. But this design can be particularly difficult to assemble—especially with a combined glass run channel and window regulator assembly. Some have a rear below belt glass run channel that gloves-over an above belt channel, thus allowing near perfect alignment. But this may complicate the fabrication or assembly of the various components—particularly if a combined glass run channel and window regulator assembly is desired. Another possible solution, including a bracket that secures the below and above belt channels together, may improve alignment concerns, but does not always ensure adequate channel alignment.

Widening the upper (above belt) channel containing the above belt seal is usually not possible because this would interfere with vehicle styling requirements. In addition, while widening the below belt glass run channel is possible, this may create a different undesirable result. The wider below belt channel may reduce the effectiveness of this channel in damping the window glass during a door slam, allowing for glass rattle. In fact, it is generally desirable to narrow down the below belt channels as much as possible in order to control full down glass rattle during door slam. Unfortunately, the more narrow the below belt glass run channel, the more difficult it is to obtain acceptable alignment with the above belt channel. Again, if the below and above belt glass channels are not aligned, excessive seal to glass friction may occur, potentially decreasing the overall reliability of the window regulator assembly.

### SUMMARY OF THE INVENTION

An embodiment contemplates a rear integrated channel/regulator for use below a belt line in a vehicle door having a window frame. The rear integrated channel/regulator may comprise a window regulator guide rail; and a below belt glass run channel, fixed to the window regulator guide rail, having an upper channel portion extending downward from a top end that is located below the beltline, a lower channel portion extending upward from a bottom end, and an intermediate channel portion extending between the upper channel portion and the lower channel portion, the upper channel portion having a first constant width, the lower channel portion having a second constant width that is smaller than the first constant width and the intermediate channel portion tapering from the first constant width adjacent to the upper channel portion to the second constant width adjacent to the lower channel portion.

An embodiment contemplates a door for a vehicle. The door may comprise a door inner panel including a window frame defining a window opening having a beltline portion and a lower door portion located below the beltline; and a rear integrated channel/regulator mounted to the lower door portion including a window regulator guide rail and a below belt glass run channel extending from and integral with the window regulator guide rail, the below belt glass run channel having an upper channel portion extending downward from a top end, a lower channel portion extending upward from a bottom end, and an intermediate channel portion extending between the upper channel portion and the lower channel portion, the upper channel portion having a first constant width, the lower channel portion having a second constant width that is smaller than the first constant width and the intermediate channel portion tapering from the first constant width to the second constant width.

An embodiment contemplates a latch/window regulator module for use in a vehicle door having a door inner panel. The latch/window regulator module may comprise a forward integrated channel/regulator mountable to the door inner panel; rear integrated channel/regulator, mountable to the door inner panel spaced from the forward integrated channel/regulator, including a rear window regulator guide rail and a rear glass run channel fixed to the rear window regulator guide rail, the rear glass run channel having an upper channel portion extending downward from a top end, a lower channel portion extending upward from a bottom end, and an intermediate channel portion extending between the upper channel portion and the lower channel portion, the upper channel portion having a first constant width, the lower channel portion having a second constant width that is smaller than the first constant width and the intermediate channel portion tapering from the first constant width to the second constant width; and a door latch assembly mounted to the rear integrated channel/regulator.

An advantage of an embodiment is that the rear integrated channel/regulator, which is securely attached to the door inner panel, will accommodate increased inboard/outboard variation in upper to lower channel misalignment, while still securely controlling the window glass near full down to avoid glass rattle during a door slam. Moreover, this is accomplished without requiring extra parts or cost.

An advantage of an embodiment is that the allowance for the increased inboard/outboard variation in upper to lower channel misalignment still maintains acceptable levels of drag on the window glass as it is moved up and down.

### BRIEF DESCRIPTION OF THE DRAWINGS

FIG. 1 is a side elevation view of a portion of a vehicle door.

FIG. 2 is a front elevation view of a portion of a rear integrated channel/regulator.

FIG. 3 is a perspective view of a portion of the rear integrated channel regulator.

FIG. 4 is a schematic illustration of a glass run channel for the rear integrated channel regulator.

### DETAILED DESCRIPTION

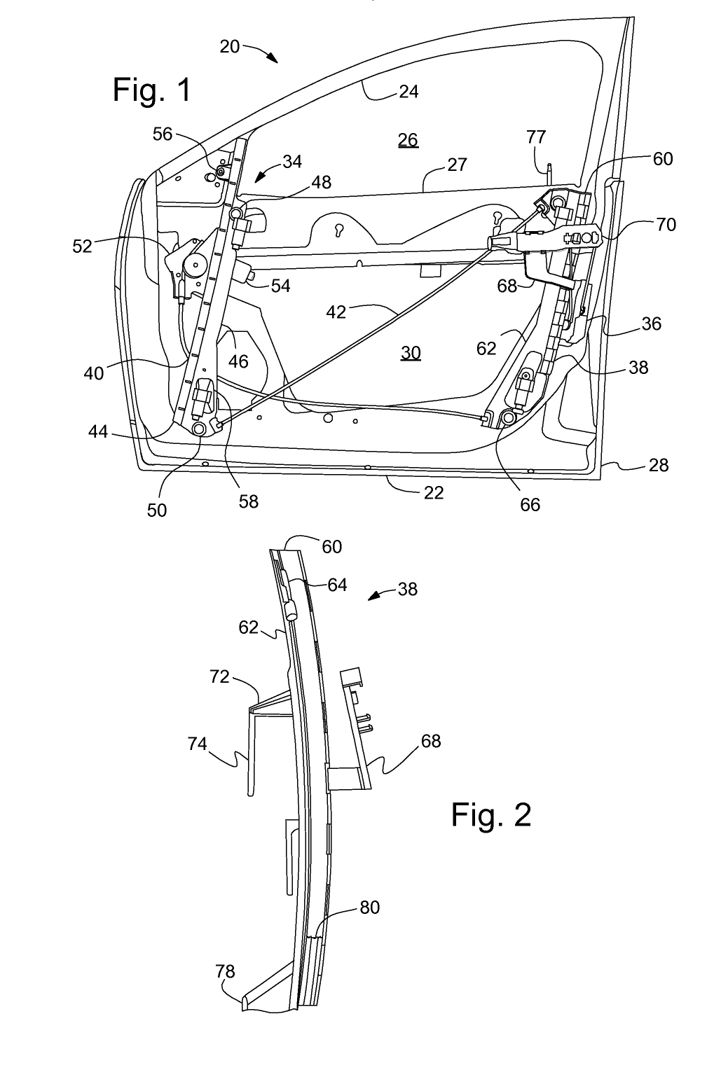

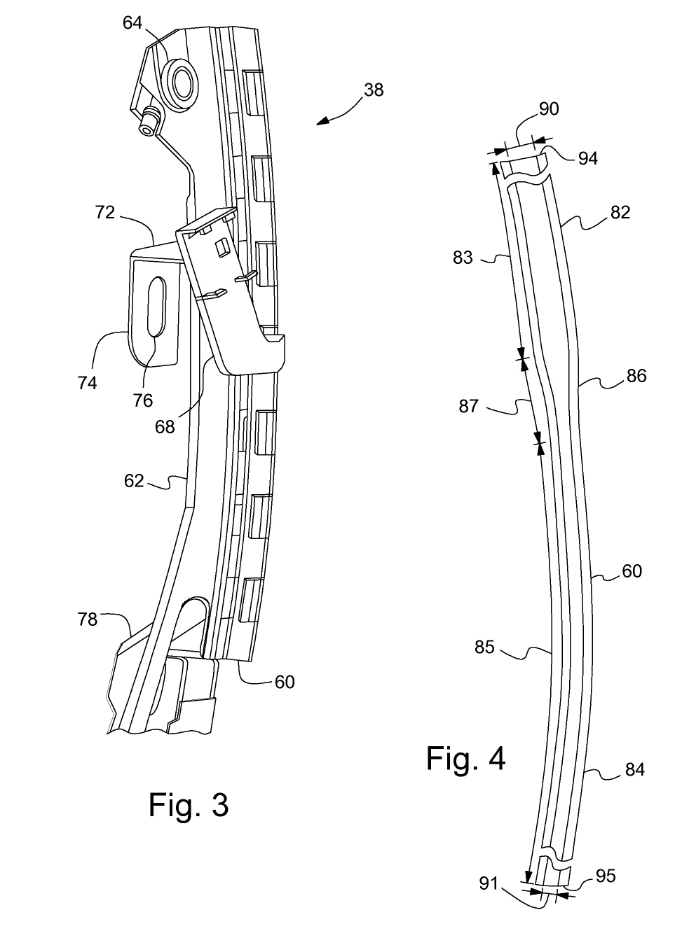

FIGS. 1-3 illustrate various portions of a vehicle door 20, having a door inner panel 22. The door inner panel 22 includes structure forming a window frame 24 that defines a window opening 26, the bottom edge 27 of which is generally referred to as a beltline, and other structure forming a lower door portion 28 that defines an access hole 30. The access hole 30 allows various components and sub-assemblies, such as a latch/window regulator module 34, to be assembled into the door 20.

Mounted to the door inner panel 22 is the latch/window regulator module 34, which includes a door latch assembly 36 mounted to a rear integrated channel/regulator 38, a forward integrated channel/regulator 40, and a window regulator cable assembly 42 (cable not shown), mounted to and extending between the rear and forward integrated channel/regulators 38, 40.

The forward integrated channel/regulator 40 may include a forward glass run channel 44 that is integral with and extends from a forward window regulator guide rail 46. The forward glass run channel 44 may extend somewhat above the beltline 27. A top front pulley 48 and a bottom front pulley 50 may mount to the forward guide rail 46 and guide a cable (not shown)—part of the window regulator cable assembly 42 that controls the vertical movement of a window glass (not shown). An integral motor flange 52 may extend from the forward integrated channel/regulator 40 and provide support for a motor 54 and cable drum (not shown). Integral upper and lower mounting flanges 56, 58, respectively, may provide a location for securing the forward integrated channel/regulator 40 to the door inner panel 22. As one will note, several different functions are performed within the door by the various features integrated into the forward integrated channel/regulator 40. Preferably, the forward integrated channel/regulator 40 is a molded plastic part, allowing these various portions to be formed integrally.

The term integral, as used herein, means that the particular elements are formed as a single monolithic piece rather than being formed separately and later assembled and secured together.

The rear integrated channel/regulator 38 also has various portions that, while being mostly formed from an integral piece, perform different functions within the door 20. The rear integrated channel/regulator 38 may include a rear below belt glass run channel 60 that is integral with and extends from a rear window regulator guide rail 62. A top rear pulley 64 and bottom rear pulley 66 may mount to the guide rail 62 and guide the cable (not shown)—part of the window regulator cable assembly 42 that controls the vertical movement of the window glass (not shown). An integral outside door handle support flange 68 may extend from the rear integrated channel/regulator 38 and support an outside handle chassis 70. A locking rod flange 72 may be integral with and extend from the rear integrated channel/regulator 38 and include a portion that forms a locking rod carrier 74. The locking rod carrier 74 may include a rod pass through hole 76 through which a vertical locking rod 77 passes and is supported. Also, an integral rear/lower door mounting flange 78 may extend from the rear integrated channel/regulator 38 and provide a location for securing the channel/regulator 38 to the door inner panel 22. A glass guide insert 80 mounts in the below belt glass run channel 60 and guides a rear edge of the window glass (not shown) therein. The glass guide insert 80 may be made of rubber or more preferably EPDM (ethylene propylene diene monomer), and may be shaped so that it fits tightly in the lower portion of the run channel 60, and fits loosely into the upper portion of the run channel 60.

FIG. 4 is a schematic drawing of the rear below belt glass run channel 60 (of the rear integrated channel regulator 38, discussed above). Most significantly, FIG. 4 illustrates the widths of various portions of the run channel 60, with the variations in width being somewhat exaggerated in this view in order to more clearly illustrate these variations. The rear below belt glass run channel 60 includes an upper channel portion 82, a lower channel portion 84, and an intermediate channel portion 86 extending between the upper and lower portions 82, 84. The upper channel portion 82 extends downward from a top end 94 of the run channel and has a constant width 90 that is significantly wider than the lower channel portion 84, which also has a constant width 91. The lower channel portion 84 extends upward from a bottom end 95 of the run channel 60. The intermediate channel portion 86 tapers down in width from upper channel width 90 to lower channel width 91. The upper channel portion 82 has a length 83 that extends a significant distance along the run channel 60, and the lower channel portion 84 has a length 85 that also extends a significant distance along the run channel 60. The term significant distance, as used herein, means at least twenty percent of the total length of the run channel 60. A length 87 of the intermediate channel portion 86 is preferably sufficient to avoid too drastic of a taper.

For example, the various dimensions for the rear below belt glass run channel 60 may include the width 90 of the upper channel portion 82 being about seventeen millimeters, and the width 91 of the lower channel portion 84 being about thirteen millimeters, with the intermediate channel portion 86 tapering from seventeen to thirteen millimeters. The lengths of the various portions may be, for example, a length 83 of about one hundred fifty millimeters plus or minus about fifty millimeters for the upper channel portion 82, a length 85 of the lower channel portion 84 of about two hundred fifty millimeters plus or minus fifty millimeters, and a length 87 of the intermediate channel portion 86 of about one hundred millimeters plus or minus about twenty five millimeters. Of course, the numbers in this example may vary somewhat depending upon the particular vehicle, door, window size, etc.

One will note that the intermediate channel portion 86 does not extend the entire or even most of the length of the glass run channel 60. And, it does not extend all of the way to the top 94 or all of the way to the bottom 95 of the glass run channel 60. The constant width upper channel portion 82 and the constant width lower channel portion 84 are intentionally provided. The greater width 90 of the upper channel portion 82 that extends for a significant length 83 allows for greater inboard/outboard alignment variation during assembly without creating the potential for binding problems due to excessive drag on the glass. Having the upper channel portion 82 extend for a significant length 83 does not create a window rattle problem since, when the window glass is most or all of the way up (i.e., not extending into the lower channel portion 84), the window glass is supported by the window frame 24. The window frame 24, then, prevents rattle when the window glass is most or all of the way up toward its closed position. On the other hand, when the window glass is most or all of the way down, the tighter constant width 91 of the lower channel portion 84 will engage enough of the window glass to prevent rattling of the window glass. And, since the length 85 of the lower channel portion 84 only extends a portion of the length of the glass run channel 60, the drag on the window glass is sufficiently reduced to avoid binding concerns. The relatively gentle taper of the intermediate channel portion 86 allows for a transition between the different widths of the two portions 82, 84 without interfering with movement of the window glass.

The particular configuration of the rear below belt glass run channel 60 shown herein allows for greater variation in misalignment between the glass run channel 60 and an above belt run channel (not shown) of the window frame 24—without creating window glass rattling or binding concerns. This greater allowable variation, in turn, allows for the integration of various features onto a rear integrated channel/regulator 40, and pre-assembly of many components before they are mounted to the door inner panel 22. These pre-assembled components, then, may be inserted through the access hole 30 and secured to the door inner panel 22, even though the integration and pre-assembly may make alignment variation between the rear below belt glass run channel 60 and an above belt glass run channel of the window frame 24 greater than with conventional components.

While certain embodiments of the present invention have been described in detail, those familiar with the art to which this invention relates will recognize various alternative designs and embodiments for practicing the invention as defined by the following claims.

What is claimed is:

1. A rear integrated channel/regulator for use below a beltline in a vehicle door having a window frame, the rear integrated channel/regulator comprising:
a window regulator guide rail; and
a below belt glass run channel, fixed to the window regulator guide rail, having an upper channel portion extending downward from a top end that is located below the beltline, a lower channel portion extending upward from a bottom end, and an intermediate channel portion extending between the upper channel portion and the lower channel portion, the upper channel portion having a first constant width, the lower channel portion having a second constant width that is smaller than the first constant width and the intermediate channel portion tapering from the first constant width adjacent to the upper channel portion to the second constant width adjacent to the lower channel portion.

2. The rear integrated channel/regulator of claim 1 wherein the window regulator guide rail is integral with the below belt glass run channel.

3. The rear integrated channel/regulator of claim 2 including a glass guide insert mounted in the below belt glass run channel.

4. The rear integrated channel/regulator of claim 1 wherein the upper channel portion has a length that is greater than twenty percent of a length of the below belt glass run channel.

5. The rear integrated channel/regulator of claim 4 wherein the lower channel portion has a length that is greater than twenty percent of the length of the below belt glass run channel.

6. The rear integrated channel/regulator of claim 1 wherein the lower channel portion has a length that is greater than twenty percent of a length of the below belt glass run channel.

7. The rear integrated channel/regulator of claim 1 including a glass guide insert mounted in the below belt glass run channel.

8. The rear integrated channel/regulator of claim 1 wherein the first constant width of the upper channel portion is about seventeen millimeters.

9. The rear integrated channel/regulator of claim 1 wherein the second constant width of the lower channel portion is about thirteen millimeters.

10. The rear integrated channel/regulator of claim 1 wherein a length of the upper channel portion is about one hundred to two hundred millimeters, a length of the lower channel portion is about two hundred to three hundred millimeters, and a length of the intermediate channel portion is about seventy five to one hundred and twenty five millimeters.

11. A door for a vehicle comprising:
a door inner panel including a window frame defining a window opening having a beltline portion and a lower door portion located below the beltline; and
a rear integrated channel/regulator mounted to the lower door portion including a window regulator guide rail and a below belt glass run channel extending from and integral with the window regulator guide rail, the below belt glass run channel having an upper channel portion extending downward from a top end, a lower channel portion extending upward from a bottom end, and an intermediate channel portion extending between the upper channel portion and the lower channel portion, the upper channel portion having a first constant width, the lower channel portion having a second constant width that is smaller than the first constant width and the intermediate channel portion tapering from the first constant width to the second constant width.

12. The door of claim 11 including a glass guide insert mounted in the below belt glass run channel.

13. The door of claim 11 wherein the upper channel portion has a length that is greater than twenty percent of a length of the below belt glass run channel.

14. The door of claim 13 wherein the lower channel portion has a length that is greater than twenty percent of the length of the below belt glass run channel.

15. The door of claim 11 wherein the lower channel portion has a length that is greater than twenty percent of a length of the below belt glass run channel.

16. The door of claim 11 wherein a length of the upper channel portion is about one hundred to two hundred millimeters, a length of the lower channel portion is about two hundred to three hundred millimeters, and a length of the intermediate channel portion is about seventy five to one hundred and twenty five millimeters.

17. A latch/window regulator module for use in a vehicle door having a door inner panel, the latch/window regulator module comprising:
a forward integrated channel/regulator mountable to the door inner panel;
rear integrated channel/regulator, mountable to the door inner panel spaced from the forward integrated channel/regulator, including a rear window regulator guide rail and a rear glass run channel fixed to the rear window regulator guide rail, the rear glass run channel having an upper channel portion extending downward from a top end, a lower channel portion extending upward from a bottom end, and an intermediate channel portion extending between the upper channel portion and the lower channel portion, the upper channel portion having a first constant width, the lower channel portion having a second constant width that is smaller than the first constant width and the intermediate channel portion tapering from the first constant width to the second constant width; and
a door latch assembly mounted to the rear integrated channel/regulator.

18. The latch/window regulator module of claim 17 wherein the rear window regulator guide rail is integral with the rear glass run channel.

19. The latch/window regulator module of claim 17 including a window regulator cable assembly connected between the forward integrated channel/regulator and the rear integrated channel/regulator.

20. The latch/window regulator module of claim 17 wherein the upper channel portion has a length that is greater than twenty percent of a length of the below belt glass run channel and the lower channel portion has a length that is greater than twenty percent of the length of the below belt glass run channel.
